(19) United States
(12) Patent Application Publication
(10) Pub. No.: US 2016/0376095 A1
(43) Pub. Date: Dec. 29, 2016

(54) LORRY AND LORRY TANK

(71) Applicant: FUJIFILM Electronic Materials Taiwan Co., Ltd., Hsinchu County (TW)

(72) Inventors: Kenichi Tanaka, Hsinchu County (TW); Hui-Peng Wang, Hsinchu County (TW); Cheng-Chieh Fan, Hsinchu County (TW); Shen-Ping Huang, Hsinchu County (TW)

(21) Appl. No.: 15/196,060

(22) Filed: Jun. 29, 2016

(30) Foreign Application Priority Data
Jun. 29, 2015 (TW) 104120975

(51) Int. Cl. B65D 88/12; B65D 90/10; B65D 90/12; B60P 3/22

(52) U.S. Cl. CPC B65D 88/12; B60P 3/22; B60P 3/225; B60P 3/226; B65D 90/10; B65D 90/12

(57) ABSTRACT

A lorry and a lorry tank are provided. The lorry tank includes a tank body and one or two return tube(s). The tank body has at least one manhole, at least one air hole, a liquid hole and a circulation hole that are communicated to a storage space inside the tank body. One end of the return tube is connected to the circulation hole, and another end of the return tube extends to the storage space.

### CROSS-REFERENCE TO RELATED APPLICATION

This application claims the priority benefit of Taiwan application serial no. 104120975, filed on Jun. 29, 2015. The entirety of the above-mentioned patent application is hereby incorporated by reference herein and made a part of this specification.

### BACKGROUND OF THE INVENTION

1. Field of the Invention

The invention generally relates to a storage tank, a lorry and a long tank, and more particularly, to a fluid storage tank and lorry.

2. Description of Related Art

As technology advances, more and more new materials have been introduced. Whether being the new materials or some of the broadly used materials, they all have to be transported to a downstream production line after being produced, so as to be used. However, some materials are very strict in terms of preservation and transportation requirements, and thus a lorry is often being used as transportation. A conventional lorry merely comprise a manhole, an air hole and a liquid hole, but this kind of design provides only the single liquid hole for a liquid material to enter and exit a storage tank of the long. As a result, a good convection of the liquid material inside the storage tank is unable to be obtained and thus is liable to an accumulation of impurities, thereby causing the material to be contaminated or deteriorated.

### SUMMARY OF THE INVENTION

The invention is directed to a lony tank and a lorry which are capable of resolving a problem in which a storage tank of the traditional lorry is liable to an accumulation of impurities.

The lorry tank of the invention includes a tank body and a return tube. The tank body has a manhole, an air hole, a liquid hole and a circulation hole communicated to a storage space inside the tank body. One end of the return tube is connected to the circulation hole, and another end of the return tube extends to the storage space.

The lony of the invention includes a head and a storage tank connected to the head. The storage tank includes a tank body and a return tube. The tank body has at least one manhole, at least one air hole, a liquid hole and a circulation hole communicated to a storage space inside the tank body. One end of the return tube is connected to the circulation hole, and another end of the return tube extends to the storage space.

In an embodiment of the invention, the storage tank further includes at least one manhole value, at least one air hole valve, a liquid hole valve and a circulation hole valve respectively mounted to the at least one manhole, the at least one air hole, the liquid hole and the circulation hole.

In an embodiment of the invention, the storage tank further includes a filtration device communicated to the liquid hole and the circulation hole and configured to filter liquid extracted from inside the storage space through the liquid hole and return filtered fluid back to the storage space via the return tube.

In an embodiment of the invention, a length of the return tube is greater than 10 cm.

In an embodiment of the invention, a distance between the another end of the return tube and the bottom of the storage space is greater than 5 cm.

In an embodiment of the invention, the return tube is a stainless steel tube or covered with Teflon on a surface thereof.

In an embodiment of the invention, the manhole, the air hole, the liquid hole and the circulation hole are located at the top of the tank body.

In an embodiment of the invention, the storage tank further includes an extraction tube having one end connected to the liquid hole and another end extends to the bottom of the tank body.

In an embodiment of the invention, the circulation hole and the liquid hole are respectively being close to the front end and the rear end of the tank body.

In an embodiment of the invention, the storage tank further includes a support and a wheel set mounted at the bottom of the tank body and respectively being close to the front end and the rear end of the tank body. The front end of the storage tank is rotatably connected to the head.

In view of the above, the lorry tank and the lorry of the invention are each configured with a circulation hole and a return tube therein. Hence, the liquid hole and the circulation hole may respectively be used as an inlet and an outlet of the fluid, so that a good convection of the fluid inside the storage tank can be obtained for preventing the accumulation of impurities.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-sectional view of a lorry tank illustrated according to an embodiment of the invention.

FIG. 2 is a schematic view a lorry illustrated according to an embodiment of the invention.

FIG. 3 is a schematic view of a lorry illustrated according to another embodiment of the invention.

### DESCRIPTION OF THE EMBODIMENTS

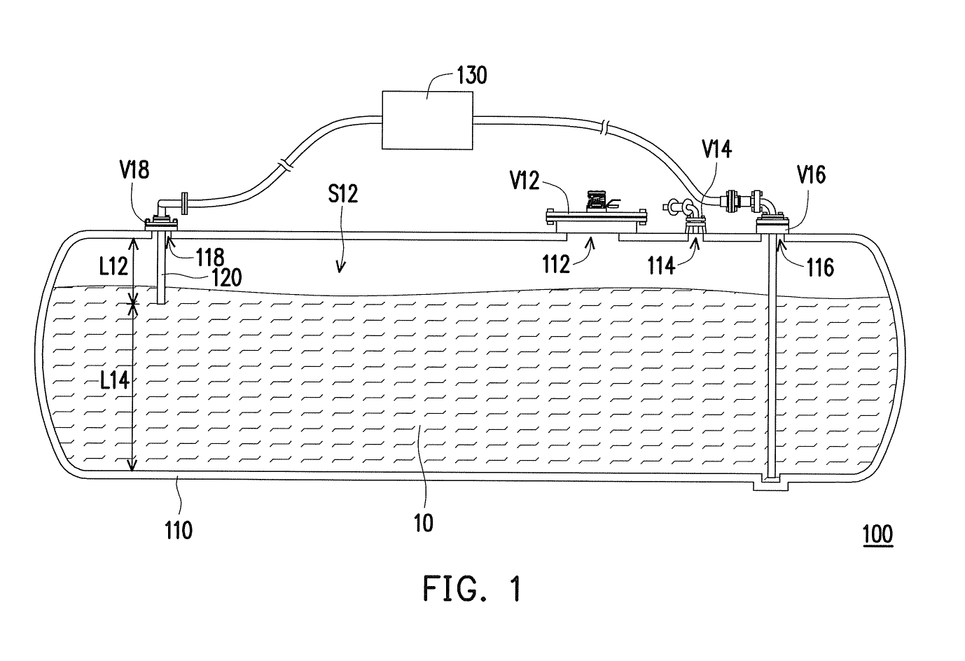

FIG. 1 is a cross-sectional view of a lorry tank illustrated according to an embodiment of the invention. Referring to FIG. 1, the lorry tank 100 of the present embodiment includes a tank body 110 and a return tube 120. The tank body 110 has a manhole 112, an air hole 114, a liquid hole 116 and a circulation hole 118. The manhole 112, the air hole 114, the liquid hole 116 and the circulation hole 118 are communicated to a storage space S12 inside the tank body 110. One end of the return tube 120 is connected to the circulation hole 118, and another end of the return tube 120 extends to the storage space S12.

The manhole 112 denotes to an opening that enables the staff to enter the storage space S12 inside the tank body 110. The size of the manhole 112 is designed mainly based on a factor of allowing the staff to pass through, and the manhole 112 of the present embedment is a circular hole with a diameter of approximately 50 cm, but the invention is not limited thereto. The manhole 112 is generally not being used to load and unload fluid to be stored in the tank body 110. Moreover, the number of the manhole 112 may also be increased.

The air hole 114 is mainly used to provide a pathway for gas to entre and exit the storage space S12 inside the tank body 110. When a liquid material 10 is inputted into the storage space S12 inside the tank body 110 through the liquid hole 116, the air hole 114 may enable the gas inside the storage space S12 to flow out, so that the liquid material 10 can be smoothly inputted into the storage space S12. Moreover, when the liquid material 10 is a material liable to produce a chemical reaction with the air, an inert gas such as nitrogen may further be injected through the air hole 114 so as to provided a better storage environmental for the liquid material 10. The air hole 114 of the present embodiment is a circular hole with a diameter of approximately 2 cm, but the invention is not limited thereto. In addition, the air hole 114 may further be communicated to a barometer (not shown), so as to control a gas pressure status inside the storage space S12. Moreover, the number of the air hole 114 may also be increased.

The liquid hole 116 and the circulation hole 118 are mainly used to provide pathways for the liquid material 10 to enter/exit the storage space S12 inside the tank body 110. The liquid hole 116 and the circulation hole 118 of the present embodiment are circular holes each with a diameter of approximately 10 cm, but the invention is not limited thereto. One of the differences between the lorry tank 100 of the present embodiment and the traditional storage tank lies in the addition of the circulation hole 118; that is, the lorry tank 100 of the present embodiment has two entrance/exit pathways for the liquid material 10. Therefore, the liquid hole 116 and the circulation hole 118 may respectively be used as a pathway for the liquid material 10 to enter the tank body 110 and a pathway for the liquid material 10 to exit the tank body 110, so that a good convection of the liquid material 10 within the storage space S12 inside the tank body 110 can be obtained, thereby resolving a problem in which impurities in the liquid material 10 may possibility be accumulated at the bottom of the tank body 110. Moreover, with the configuration of the return tube 120, the liquid material 10 may be prevented of directly dropping from the top when returning back into the storage space S12, and thus a possibility of producing bubbles or other circumstances affecting the quality of the liquid material 10 may be reduced.

In one embedment of the invention, the lorry tank 100 further includes a manhole value V12, an air hole valve V14, a liquid hole valve V16 and a circulation hole valve V18 respectively mounted to the manhole 112, the air hole 114, the liquid hole 116 and the circulation hole 118. The manhole value V12, the air hole valve V14, the liquid hole valve V16 and the circulation hole valve V18 are configured to isolated the storage space S12 inside the tank body 110 from the outside. Inner walls of the lony tank 100 may selectively be coated with a layer of Teflon or other material not adhesive to the liquid material 10.

In an embodiment of the invention, the lorry tank 100 further includes a filtration device 130 communicated to the liquid hole 116 and the circulation hole 118 and configured to filter the liquid material 10 extracted from inside the storage space S12 through the liquid hole 116 and return the filtered liquid material 10 back into the storage space S10 via the return tube 120. The traditional storage tank, due to not having a circulation hole and only having a single liquid hole, is thus unable to filter the fluid stored therein. The lorry tank 100 of the present embodiment, due to having the liquid hole 116 and the circulation hole 118, is thus able to filter the liquid material 10 inside the storage space S12 in collaboration with the filtration device 130, and thereby significantly improves the quality of the liquid material 10 stored therein. Moreover, the lorry tank 100 may even be used as a long-term storage space for the liquid material 10 before transportation.

In the present embodiment, a length L12 of the return tube 120 is, for example, greater than 10 cm, a distance L14 between an end of the return tube 120 away from the circulation hole 118 and the bottom of the storage space S12 is, for example, greater than 5 cm, and the return tube 120 is a stainless steel tube or the surface of the return tube 120 is covered with Teflon, but the invention is not limited thereto.

In the present embodiment, the manhole 112, the air hole 114, the liquid hole 116 and the circulation hole 118 are, for example, located at the top of the tank body 110, but the invention is not limited thereto. For instance, when the liquid hole 116 is mainly used for exporting the liquid material 10, the liquid hole 116 may be disposed at the bottom or close to the bottom of the tank body 110. The lorry tank 100 of the present embodiment may further include an extraction tube 140 having one end connected to the liquid hole 116 and another end extends to the bottom of the tank body 110. With the configuration of the extraction tube 140, the liquid material 10 may be extracted from the bottom of the storage space S12, and thereby prevent the liquid material 10 at the bottom from being deteriorated due to a long-term lack of liquidity. In the present embodiment, the circulation hole 118 and the liquid hole 116 are respectively being close to the front end and the rear end of the tank body 110. In other words, the circulation hole 118 and the liquid hole 116 are respectively being close to the two ends of the tank body 110 and are not being close to each other, so that the liquid material 10 can produce better convection. Herein, the front end of the tank body 110 denotes to an end of the tank body 110 that faces towards the front during the process of transportation, but the invention does not limit which one of the circulation hole 118 and the liquid hole 116 is to be close to the front end of the tank body 110.

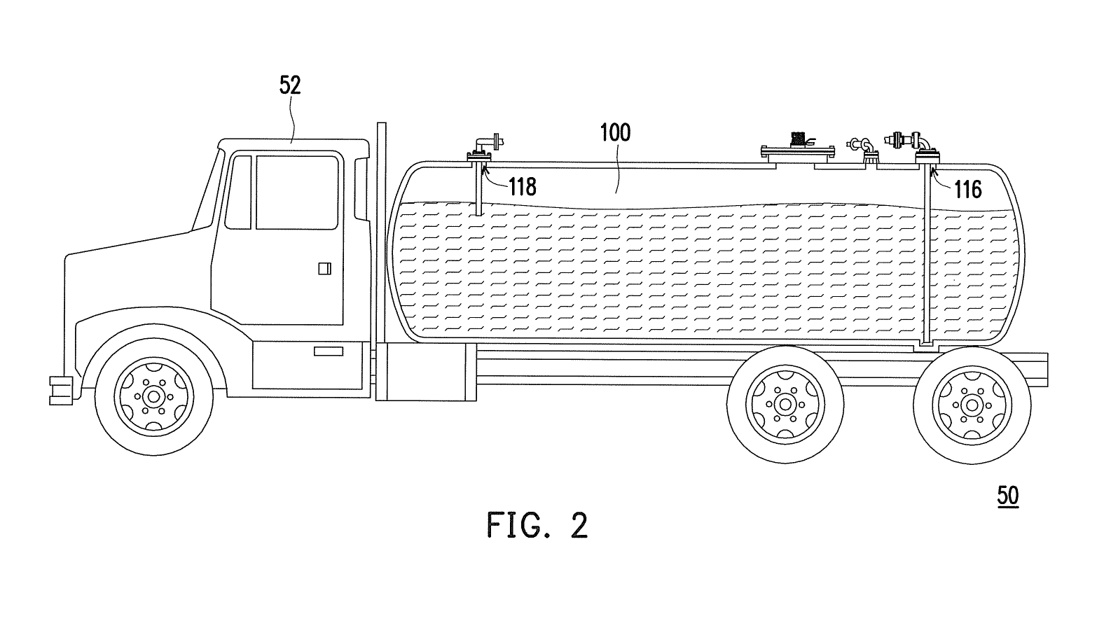

FIG. 2 is a schematic view a lorry illustrated according to an embodiment of the invention. Referring to FIG. 2, the lony 50 of the present embodiment includes a head 52 and a lorry tank 100 connected to the head 52. The lorry tank 100 is the same as the lorry tank 100 of FIG. 1, and thus details regarding thereof will be omitted herein. The lorry 50 of the present embodiment is designed as having the storage tank 100 being directly fixed on a carriage behind the head 52 for an example, and this kind of design is more suitable for a small lorry tank 100, but the invention is not limited thereto. In the present embodiment, the circulation hole 118 is, for example, closer to the head 52 and the liquid hole 116 is, for example, further away from the head 52, but the invention is not limited thereto.

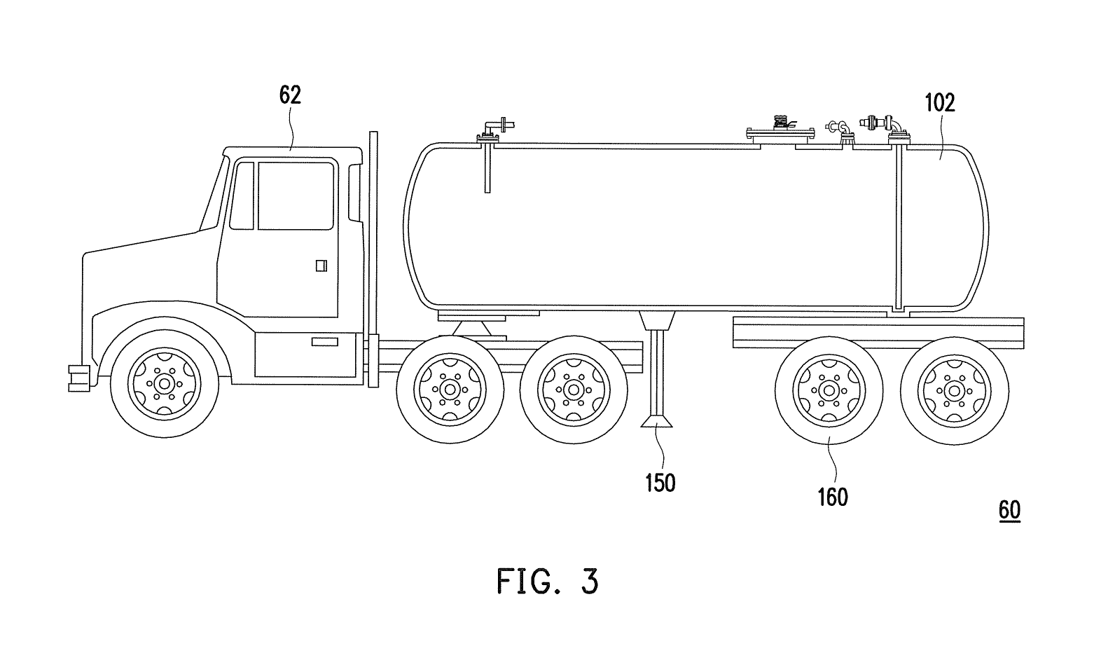

FIG. 3 is a schematic view of a lorry 60 illustrated according to another embodiment of the invention. Referring to FIG. 3, the lorry 60 of the present embodiment is similar to the lorry 50 of FIG. 2, and thus only the differences between the two are described herein. A lorry tank 102 of the present embodiment is similar to the long tank 100 of FIG. 1, but the lorry tank 102 of the present embodiment further includes a support 150 and a wheel set 160, which are both mounted at the bottom of the tank body 110. The support 150 is close to the front end of the tank body 110, and the wheel set 160 is close to the rear end of the tank body 110. The front end of the lorry tank 100 is rotatably connected to the head 62. In other words, the head 62 of the lorry 60 of the present embodiment may be a head of a commonly seen tractor trailer, and can be replaced. This kind of design is more suitable for a large lorry tank 100, but the invention is not limited thereto.

In summary, the lorry tank and the lorry of the invention are each configured with a circulation hole and a return tube therein. Hence, the liquid hole and the circulation hole may respectively be used as an inlet and an outlet of the fluid, so that a good convection of the fluid inside the storage tank can be obtained for preventing the accumulation of impurities.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A lorry tank, comprising:
a tank body, having a manhole, an air hole, a liquid hole and a circulation hole communicated to a storage space inside the tank body; and
a return tube, having one end connected to the circulation hole and another end extends to the storage space.

2. The lorry tank as recited in claim 1, further comprising a manhole value, an air hole valve, a liquid hole valve and a circulation hole valve respectively mounted to the manhole, the air hole, the liquid hole and the circulation hole.

3. The lorry tank as recited in claim 1, further comprising a filtration device communicated to the liquid hole and the circulation hole so as to filtered fluid extracted from inside the storage space through the liquid hole and return filtered fluid back to the storage space via the return tube.

4. The lorry tank as recited in claim 1, wherein a length of the return tube is greater than 10 cm.

5. The lorry tank as recited in claim 1, wherein a distance between the another end of the return tube and the bottom of the storage space is greater than 5 cm.

6. The lorry tank as recited in claim 1, wherein the return tube is a stainless steel tube or covered with Teflon on a surface thereof.

7. The lorry tank as recited in claim 1, wherein the manhole, the air hole, the liquid hole and the circulation hole are located on the top of the tank body.

8. The lorry tank as recited in claim 7, further comprising an extraction tube having one end connected to the liquid hole and another end extends to the bottom of the tank body.

9. The lorry tank as recited in claim 1, wherein the circulation hole and the liquid hole are respectively being close to the front end and the rear end of the tank body.

10. The lorry tank as recited in claim 1, further comprising a support and a wheel set mounted at the bottom of the tank body, respectively being close to the front end and the rear end of the tank body, and configured to collaboratively support the tank body on the ground.

11. A lorry, comprising:
a head;
a storage tank, connected to the head, wherein the storage tank comprises:
a tank body, having at least one manhole, at least one air hole, a liquid hole and a circulation hole communicated to a storage space inside the tank body; and
a return tube, having one end connected to the circulation hole and another end extends to the storage space.

12. The lorry as recited in claim 11, wherein the storage tank further comprises at least one manhole value, at least one air hole valve, a liquid hole valve and a circulation hole valve respectively mounted to the at least one manhole, the at least one air hole, the liquid hole and the circulation hole.

13. The lorry as recited in claim 12, wherein the storage tank further comprises a filtration device communicated to the liquid hole and the circulation hole and configured to filtered fluid extracted from inside the storage space through the liquid hole and return filtered fluid back to the storage space via the return tube.

14. The lorry as recited in claim 11, wherein a length of the return tube is greater than 10 cm.

15. The lorry as recited in claim 11, wherein a distance between the another end of the return tube and the bottom of the storage space is greater than 5 cm.

16. The lorry as recited in claim 11, wherein the return tube is a stainless steel tube or is covered with Teflon on a surface thereof.

17. The lorry as recited in claim 11, wherein the at least one manhole, the at least one air hole, the liquid hole and the circulation hole are located at the top of the tank body.

18. The lorry as recited in claim 17, wherein the storage tank further comprises an extraction tube having one end connected to the liquid hole and another end extends to the bottom of the tank body.

19. The lorry as recited in claim 11, wherein the circulation hole and the liquid hole are respectively being close to the front end and the rear end of the tank body.

20. The lorry as recited in claim 11, wherein the storage tank further comprises a support and a wheel set mounted at the bottom of the tank body and respectively being close to the front end and the rear end of the tank body, and the front end of the storage tank is rotatably connected to the head.
